(19) United States
(12) Patent Application Publication
(10) Pub. No.: US 2013/0147950 A1
(43) Pub. Date: Jun. 13, 2013

(54) VIDEO TRANSMISSION SYSTEM, VIDEO TRANSMISSION METHOD AND COMPUTER PROGRAM

(71) Applicant: DWANGO Co., Ltd., Tokyo (JP)

(72) Inventor: Shinnosuke IWAKI, Tokyo (JP)

(73) Assignee: DWANGO CO., LTD., Tokyo (JP)

(21) Appl. No.: 13/706,538

(22) Filed: Dec. 6, 2012

(30) Foreign Application Priority Data
Dec. 9, 2011 (JP) 2011-270292

(51) Int. Cl. H04N 7/18

(52) U.S. Cl. CPC H04N 7/183
USPC 348/143

(57) ABSTRACT

A video of a field of view of a patron in a venue is made different from a video delivered to a viewer of a user terminal. A video from an imaging device that images the video is received as an input, and the video includes all or a part of an image display device arranged near a performer and the performer. A mask process is performed on all or a part of a portion of the video in which the image display device is imaged. The video that has been subjected to the mask process is transmitted via a network.

### BACKGROUND OF INVENTION

1. Field of the Invention

The present invention relates to a technique of processing a captured video. Priority is claimed on Japanese Patent Application No. 2011-270292, filed Dec. 9, 2011, the contents of which are incorporated herein by reference.

2. Description of Related Art

Video delivery systems that allow moving pictures (videos) captured in clubs with live shows, event sites, or the like to be almost simultaneously viewed at remote sites have been proposed. A video delivery system discussed in JP 2011-103522 A has the following configuration. A camera captures a live show performed in a club, and transmits video data to a delivery server in real time. Here, when a user terminal requests viewing of a live video of an artist who is performing a live show, the delivery server delivers video data consecutively received from the camera to the user terminal.

However, when a video captured in a club with a live show or in an event site (hereinafter referred to simply as a “venue”) is displayed on the user terminal as is, a variety of problems may occur. For example, assuming that a performance is performed according to point-of-view positions of patrons in the venue, when videos of the venue captured at different point-of-view positions are displayed on the user terminal as is, the performance is not suitably reflected in the video, and thus a viewer of the user terminal may feel dissatisfied.

### SUMMARY OF THE INVENTION

In light of the foregoing, the present invention is directed to provide a technique by which a video of a field of view of a patron in the venue is made different from a video delivered to the viewer of the user terminal.

According to an aspect of the present invention, there is provided a video transmission system including a video input unit that receives a video from an imaging device that images the video as an input, the video including all or a part of an image display device arranged near a performer and the performer, a mask processing unit that performs a mask process on all or a part of a portion of the video in which the image display device is imaged, and a transmitting unit that transmits the video that has been subjected to the mask process via a network.

According to an aspect of the present invention, in the video transmission system, the image display device displays all or a part of the video imaged by the imaging device.

According to an aspect of the present invention, in the video transmission system, the mask processing unit determines the portion of the video in which the image display device is imaged as a masking portion, and synthesizes another image on the masking portion.

According to an aspect of the present invention, there is provided a video transmission method including receiving a video from an imaging device that images the video as an input, the video including all or a part of an image display device arranged near a performer and the performer, performing a mask process on all or a part of a portion of the video in which the image display device is imaged, and transmitting the video that has been subjected to the mask process via a network.

According to an aspect of the present invention, there is provided a computer-readable recording medium in which a computer program is recorded, the computer program causes a computer to execute receiving a video from an imaging device that images the video as an input, the video including all or a part of an image display device arranged near a performer and the performer, performing a mask process on all or a part of a portion of the video in which the image display device is imaged, and transmitting the video that has been subjected to the mask process via a network.

According to the embodiments of the present invention, it is possible for a video of a field of view of a patron in the venue to be made different from a video delivered to the viewer of the user terminal.

### BRIEF DESCRIPTION OF THE DRAWINGS

FIG. 1 is a system configuration diagram illustrating a system configuration of a first embodiment (a delivery system 1) of the present invention;

FIG. 2 is a schematic block diagram illustrating a functional configuration of a venue display control system 40 according to the first embodiment;

FIG. 3 is a schematic block diagram illustrating a functional configuration of a video transmission system 50 according to the first embodiment;

FIG. 4 is a diagram illustrating a concrete example of a state of venue equipment 10 according to the first embodiment;

FIG. 5 is a diagram illustrating an outline of a process of a masking portion-determining unit 502;

FIG. 6A to FIG. 6C are diagrams illustrating a concrete example of an image generated in the delivery system 1 according to the first embodiment;

FIG. 7 is a sequence diagram illustrating the flow of a process according to the first embodiment (the delivery system 1);

FIG. 8 is a system configuration diagram illustrating a system configuration according to a second embodiment (a delivery system la) of the present invention;

FIG. 9 is a schematic block diagram illustrating a functional configuration of a venue display control system 40a according to the second embodiment;

FIG. 10 is a schematic block diagram illustrating a functional configuration of a video transmission system 50a according to the second embodiment;

FIG. 11 is a diagram illustrating a concrete example of a state of venue equipment 10 according to the second embodiment;

FIG. 12A to FIG. 12D are diagrams illustrating a concrete example of an image generated in the delivery system 1a according to the second embodiment; and

FIG. 13 is a sequence diagram illustrating the flow of a process according to the second embodiment (the delivery system 1a).

### DETAILED DESCRIPTION OF THE INVENTION

### First Embodiment

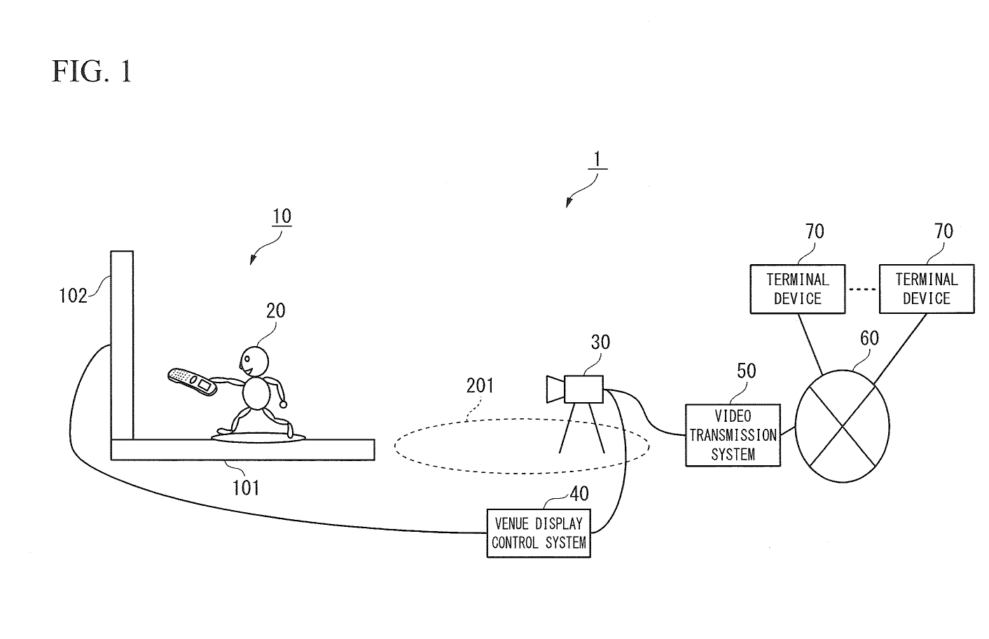

FIG. 1 is a system configuration diagram illustrating a system configuration of a first embodiment (a delivery system 1) of the present invention. The delivery system 1 includes venue equipment 10, an imaging device 30, a venue display control system 40, and a video transmission system 50. Data of a video generated by the delivery system 1 is delivered to a terminal device 70 via a network 60 through the video transmission system 50.

The venue equipment 10 includes a stage 101 and an image display device 102.

The stage 101 is a place at which the performer 20 is positioned.

The image display device 102 is a device including a display surface, and displays an image on the display surface according to control of a display control unit 402 of the venue display control system 40. For example, the display surface may have a configuration in which a plurality of light-emitting diodes (LEDs) are arranged, a configuration in which a plurality of display devices are arranged, or a configuration of any other form. The image display device 102 is arranged near the stage 101. In the image display device 102, the display surface is arranged toward an audience seat 201 and the imaging device 30 so that the display surface can be seen from the audience seat 201 and the imaging device 30 installed in the venue. Further, the image display device 102 is arranged such that patrons positioned in the audience seat 201 can see all or a part thereof and the performer 20 at the same time (that is, all or a part thereof and the performer 20 can come within the same field of view). Similarly, the image display device 102 is arranged such that the imaging device 30 can capture all or a part thereof and the performer 20 at the same time (that is, all or a part thereof and the performer 20 can come within the same field of view). In the example illustrated in FIG. 1, the image display device 102 is arranged behind the stage 101 when seen from the audience seat 201 and the imaging device 30.

The performer 20 performs on the stage 101 for the patrons. The performer 20 may be a living object such as a human or animal or a device such as a robot.

The imaging device 30 captures the performer 20 and all or a part of the image display device 102. The imaging device 30 outputs the imaged video to the venue display control system 40 and the video transmission system 50.

The venue display control system 40 controls the image display device 102, and causes the video imaged by the imaging device 30 to be displayed on the display surface.

The video transmission system 50 performs a mask process on the video imaged by the imaging device 30 and generates masked video data. The video transmission system 50 performs communication with the terminal device 70 via the network 60. The video transmission system 50 transmits the masked video data to the terminal device 70.

The network 60 may be a wide area network such as the Internet or a narrow area network (an in-house network) such as a local area network (LAN) or a wireless LAN.

Examples of the terminal device 70 include a mobile phone, a smart phone, a personal computer (PC), a personal digital assistant (PDA), a game machine, a television receiver, and a dedicated terminal device. The terminal device 70 receives the masked video data from the video transmission system 50 via the network 60, and displays the received masked video data.

Next, the venue display control system 40 and the video transmission system 50 will be described in detail.

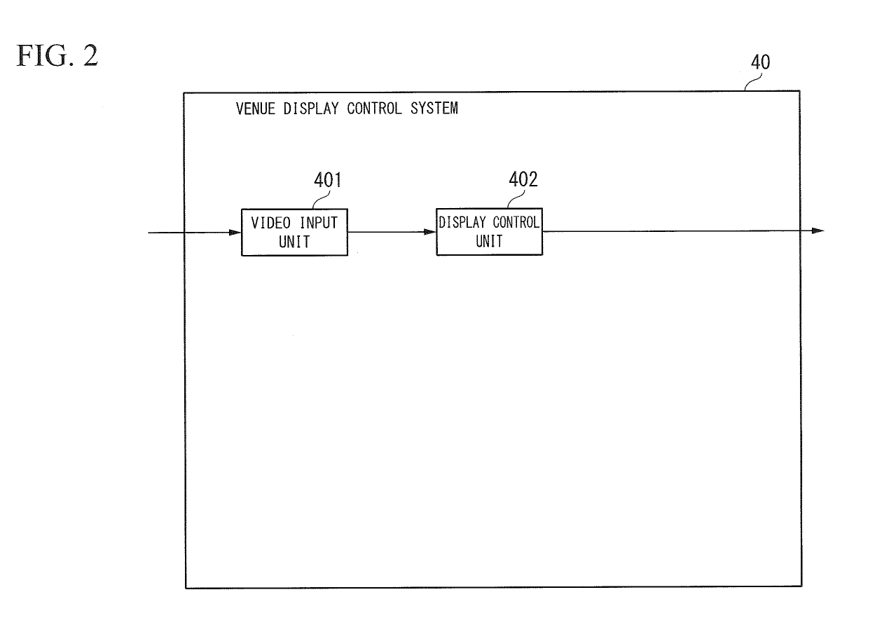

FIG. 2 is a schematic block diagram illustrating a functional configuration of the venue display control system 40 according to the first embodiment. The venue display control system 40 is configured with one or more information-processing devices. For example, when the venue display control system 40 is configured with a single information-processing device, the information-processing device includes a central processing unit (CPU), a memory, and an auxiliary storage device which are connected via a bus, and executes a venue display control program. As the venue display control program is executed, the information-processing device functions as a device including a video input unit 401 and the display control unit 402. Here, some or all functions of the venue display control system 40 may be implemented using hardware such as an application-specific integrated circuit (ASIC), a programmable logic device (PLD), or a field-programmable gate array (FPGA). Further, the venue display control system 40 may be implemented by dedicated hardware. The venue display control program may be recorded in a computer-readable recording medium. The computer-readable recording medium is a memory device including, for example, a transferable medium such as a flexible disk, an optical magnetic disc, a read-only memory (ROM), a compact disc read-only memory (CD-ROM), a hard disk built in a computer system, or the like.

The video imaged by the imaging device 30 is input to the venue display control system 40 through the video input unit 401.

The display control unit 402 causes the video input through the video input unit 401 to be displayed on the image display device 102. The video imaged by the imaging device 30 (for example, a posture of the performer 20) is displayed on the image display device 102 with little delay.

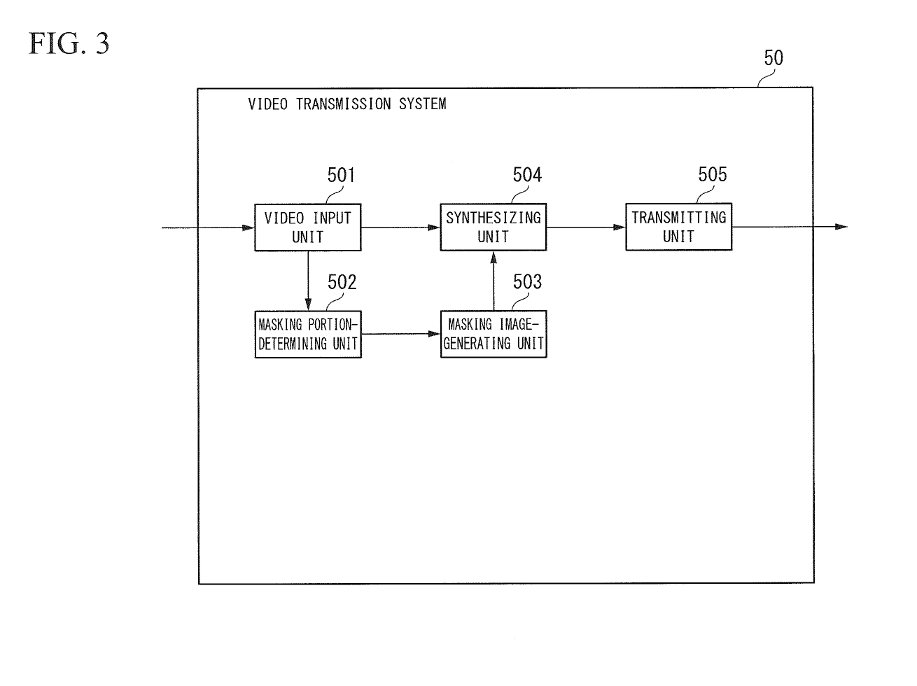

FIG. 3 is a schematic block diagram illustrating a functional configuration of the video transmission system 50 according to the first embodiment. The video transmission system 50 is configured with one or more information-processing devices. For example, when the video transmission system 50 is configured with a single information-processing device, the information-processing device includes a CPU, a memory, an auxiliary storage device, and the like, which are connected to one another via a bus, and executes a video transmission program. As the video transmission program is executed, the information-processing device functions as a device including a video input unit 501, a masking portion-determining unit 502, a masking image-generating unit 503, a synthesizing unit 504, and a transmitting unit 505. Further, all or some functions of the video transmission system 50 may be implemented using hardware such as an ASIC, a PLD, or an FPGA. Further, the video transmission system 50 may be implemented by dedicated hardware. The video transmission program may be recorded in a computer-readable recording medium. The computer-readable recording medium is a memory device including, for example, a transferable medium such as a flexible disk, an optical magnetic disc, a ROM, a CD-ROM, a hard disk built into a computer system, or the like.

The video imaged by the imaging device 30 is input to the video transmission system 50 through the video input unit 501. Hereinafter, a video input through the video input unit 501 is referred to as an “input video.”

The masking portion-determining unit 502 determines a portion (hereinafter referred to as a “masking portion”) to be masked on an image plane of the input video at intervals of a predetermined timing. The masking portion is all or a part of a portion in which the image display device 102 is captured in the input video. For example, the predetermined timing may correspond to each frame or a predetermined number of frames or may be a timing at which a change in a frame exceeds a threshold value or any other timing.

The masking image-generating unit 503 generates an image (hereinafter referred to as a “masking image”) used to mask the masking portion determined by the masking portion-determining unit 502.

The synthesizing unit 504 synthesizes the masking image with the input video, and generates data (hereinafter referred to as a “masked video data”) of the masked video. The synthesizing unit 504 outputs the masked video data to the transmitting unit 505.

The transmitting unit 505 transmits the masked video data generated by the synthesizing unit 504 to the terminal device 70 via the network 60.

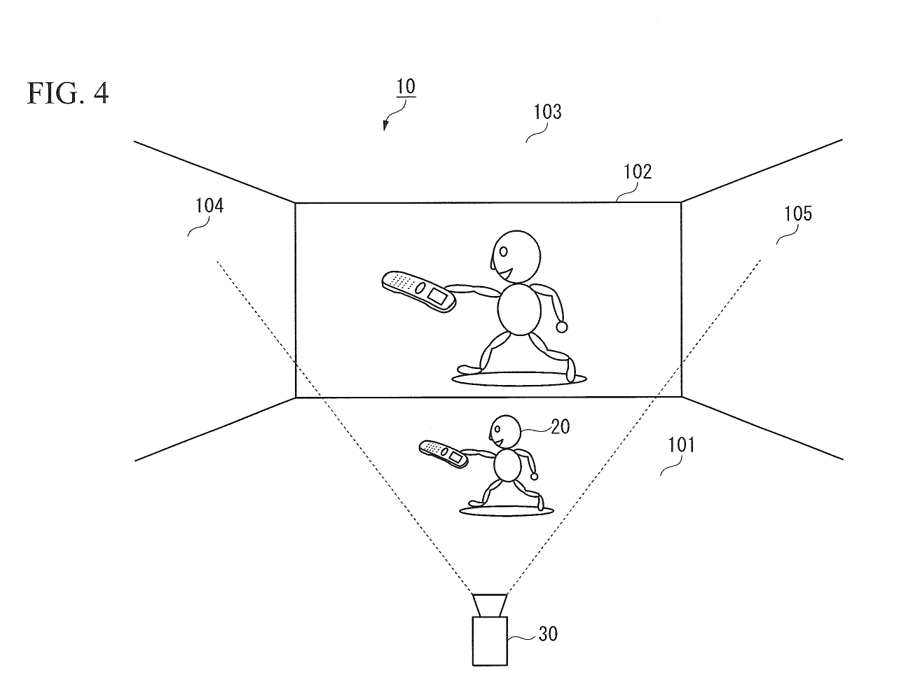

FIG. 4 is a diagram illustrating a concrete example of a state of the venue equipment 10 according to the first embodiment. In the example of FIG. 4, the performer 20 performs on the stage 101. The image display device 102 is arranged at a back side near the performer 20 on the stage 101. In addition, a ceiling 103, a left wall 104, and a right wall 105 are arranged near the performer 20 on the stage 101. The imaging device 30 images the venue equipment 10 and the performer 20. The video imaged by the imaging device 30 is displayed on the image display device 102 through the venue display control system 40. As described above, the imaged video is displayed on the image display device 102 with little delay, and thus the posture of the performer 20 almost matches the posture disposed on the image display device 102.

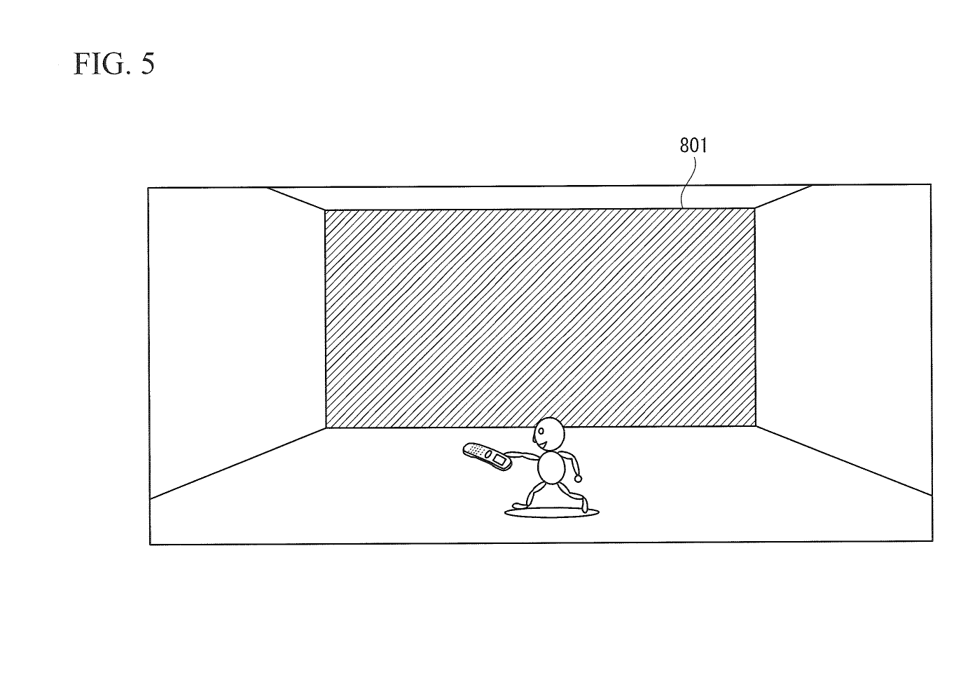

FIG. 5 is a diagram illustrating an outline of a process of the masking portion-determining unit 502. For example, the masking portion-determining unit 502 determines a portion in which the image display device 102 is captured as the masking portion. In the venue equipment 10 according to the present embodiment, the image display device 102 is arranged as a wall surface at the back side of the stage 101. For this reason, the masking portion-determining unit 502 determines a portion (a portion indicated by a reference numeral 801 in FIG. 5) in which the image display device 102 is captured as the masking portion.

Hereinafter, a plurality of concrete examples of a process of determining the masking portion through the masking portion-determining unit 502 will be described.

(First Determining Method)

Next, among concrete examples of the process of the masking portion-determining unit 502, a first determining method will be described. The delivery system 1 further includes a distance image-imaging device in addition to the configuration illustrated in FIG. 1. A point-of-view position and a field of view of the distance image-imaging device are set to be almost the same as a point-of-view position and a field of view imaged by the imaging device 30. The distance image-imaging device images a distance image on each frame of the input video. The distance image refers to an image having a distance from a point-of-view position of the distance image-imaging device to an object shown in a pixel as each pixel value. The distance image-imaging device repeatedly measures a distance, generates a distance image at each timing, and outputs the distance image.

The masking portion-determining unit 502 receives the distance image imaged by the distance image-imaging device as an input. The masking portion-determining unit 502 stores a threshold value related to a distance value in advance. The masking portion-determining unit 502 compares each pixel value of the distance image with the threshold value, and determines whether or not each pixel is a pixel in which the image display device 102 is captured. Here, when it is determined that a certain pixel is a pixel in which the image display device 102 is captured, a person (for example, the performer 20 on the stage 101) or an object (for example, equipment installed on the stage 101) positioned ahead of the image display device 102 is captured through the certain pixel. The masking portion-determining unit 502 determines the pixel in which the image display device 102 is captured as a part of the masking portion. The masking portion-determining unit 502 performs the above-described determination on all pixels of the distance image and determines the masking portion.

The first determining method is effective when an object (the image display device 102) to be masked is configured to have almost a constant distance from the distance image-imaging device. For example, it is effective when the image display device 102 is configured as a substantial plane installed at the back side of the stage 101 as illustrated in FIG. 4.

(Second Determining Method)

Next, among concrete examples of the process of the masking portion-determining unit 502, a second determining method will be described. In the second determining method, the delivery system 1 further includes the distance image-imaging device and has the same configuration as described above.

The masking portion-determining unit 502 receives the distance image imaged by the distance image-imaging device as an input. The masking portion-determining unit 502 stores a threshold value related to a distance value in advance for each pixel. The masking portion-determining unit 502 compares a threshold value corresponding to a pixel with a pixel value for each pixel value of the distance image, and determines whether or not each pixel is a pixel in which the image display device 102 is captured. Here, when it is determined that a certain pixel is a pixel in which the image display device 102 is captured, a person (for example, the performer 20 on the stage 101) or an object (for example, equipment installed on the stage 101) positioned ahead of the image display device 102 is captured through the certain pixel. The masking portion-determining unit 502 determines the pixel in which the image display device 102 is captured as a part of the masking portion. The masking portion-determining unit 502 performs the above-described determination on all pixels of the distance image and determines the masking portion.

The second determining method is effective when an object (the image display device 102) to be masked is configured not to have a constant distance from the distance image-imaging device. For example, when the image display device 102 is arranged on the left wall 104 or the right wall 105 illustrated in FIG. 4, the distance between the image display device 102 and the distance image-imaging device has a large width. Even in this case, it is possible to appropriately determine whether or not a pixel is a pixel in which the image display device 102 is captured.

(Third Determining Method)

Next, among concrete examples of the process of the masking portion-determining unit 502, a third determining method will be described. In the third determining method, a predetermined wavelength light-receiving device is provided instead of the distance image-imaging device. Further, in the third determining method, the image display device 102 includes a light-emitting element (hereinafter referred to as a “determination light-emitting element”) that emits light having a different wavelength from visible light. The determination light-emitting element is arranged throughout the image display device 102. Preferably, a distance between the arranged determination light-emitting elements is appropriately set by a relationship with a field of view or a resolution of the predetermined wavelength light-receiving device or the like

A point-of-view position and a field of view of the predetermined wavelength light-receiving device are set to be almost the same as a point-of-view position and a field of view at which the imaging device 30 performs imaging. The predetermined wavelength light-receiving device generates an image (hereinafter referred to as a “determination image”) used to discriminate light emitted from the determination light-emitting element from light having a different wavelength. For example, the predetermined wavelength light-receiving device may include a filter that allows passage of light with a wavelength emitted by the determination light-emitting element before the light-receiving element of the own device, and generates the determination image. The predetermined wavelength light-receiving device images the determination image on each frame of the input video. The predetermined wavelength light-receiving device repeatedly receives light, generates a determination image at each timing, and outputs the determination image.

The masking portion-determining unit 502 receives the determination image generated by the predetermined wavelength light-receiving device as an input. The masking portion-determining unit 502 determines that a pixel in which light emitted from the determination light-emitting element is imaged in the determination image is the pixel in which the image display device 102 is captured. Here, when a certain pixel is determined as the pixel in which the image display device 102 is captured, a person (for example, the performer 20 on the stage 101) or an object (for example, equipment installed on the stage 101) positioned ahead of the image display device 102 is captured through the certain pixel. The masking portion-determining unit 502 determines the pixel in which the image display device 102 is captured as a part of the masking portion. The masking portion-determining unit 502 performs the above-described determination on all pixels of the distance image and determines the masking portion.

The third determining method is effective when an object (the image display device 102) to be masked is configured not to have a constant distance from the distance image-imaging device. For example, when the image display device 102 is arranged on the left wall 104 or the right wall 105 illustrated in FIG. 4, the distance between the image display device 102 and the distance image-imaging device has a large width. Even in this case, it is possible to appropriately determine whether or not a pixel is a pixel in which the image display device 102 is captured.

The concrete examples of the process of determining the masking portion through the masking portion-determining unit 502 have been described above, but the masking portion-determining unit 502 may determine the masking portion by a method different from the above-described methods.

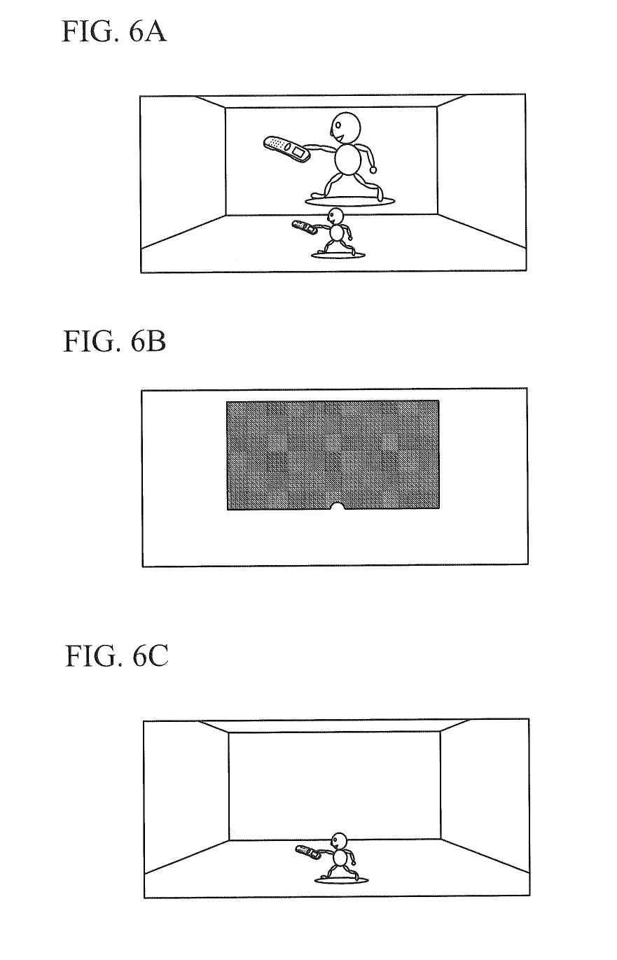

FIG. 6A to FIG. 6C are diagrams illustrating a concrete example of an image generated in the delivery system 1 according to the first embodiment. FIG. 6A is a diagram illustrating a concrete example of a video generated by the imaging device 30. FIG. 6B is a diagram illustrating a concrete example of the masking image. FIG. 6C is a diagram illustrating a concrete example of the masked video data generated by the synthesizing unit 504.

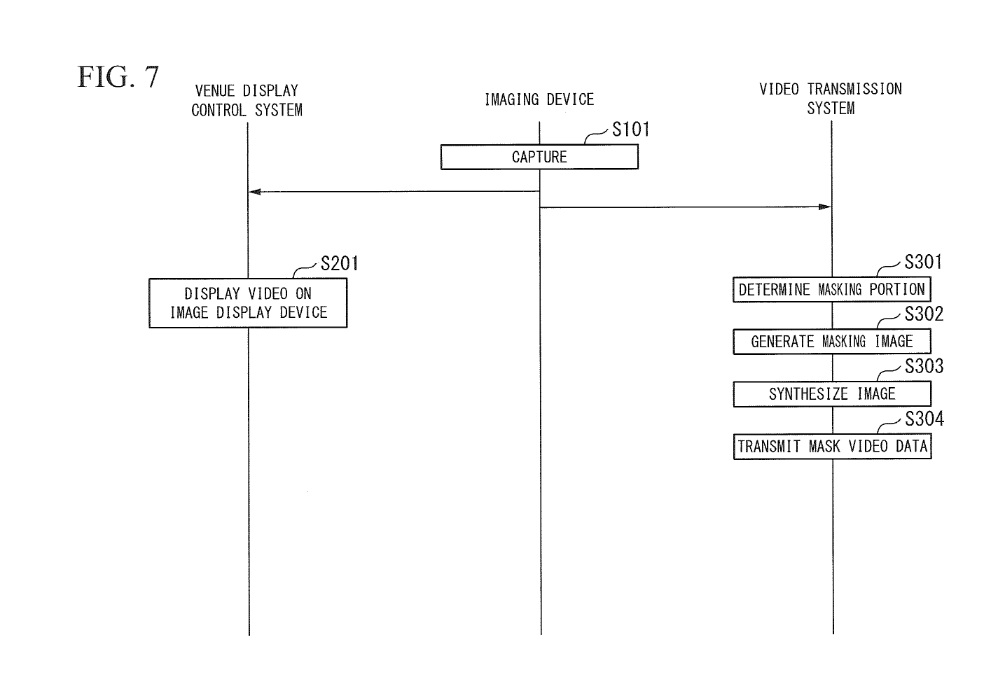

FIG. 7 is a sequence diagram illustrating the flow of a process according to the first embodiment (the delivery system 1). The imaging device 30 images the image display device 102 and the performer 20 (step S101). For example, the video imaged by the imaging device 30 is a video illustrated in FIG. 6A. The imaging device 30 outputs the imaged video to the venue display control system 40 and the video transmission system 50.

The venue display control system 40 causes the video imaged by the imaging device 30 to be displayed on the display surface of the image display device 102 (step S201). At this time, the display control unit 402 of the venue display control system 40 may enlarge a part (for example, a part in which the performer 20 is captured) of the imaged video and cause the enlarged part to be displayed on the image display device 102. By performing this control, it is possible to cause the posture of the performer 20 to be displayed on the image display device 102 in a large way as illustrated in FIG. 6A.

The masking portion-determining unit 502 of the video transmission system 50 determines the masking portion based on the video imaged by the imaging device 30 (step S301). The masking image-generating unit 503 generates an image (the masking image) used to mask the masking portion determined by the masking portion-determining unit 502 (step S302). For example, the masking image generated based on the video of FIG. 6A is the masking image illustrated in FIG. 6B. The masking image illustrated in FIG. 6B is generated as a binary image of a white pixel and a black pixel. A video of a portion of a white pixel of the masking image is displayed as is after being synthesized. However, a video of a portion of a black pixel of the masking image is masked after being synthesized, and another video is displayed. For example, a portion of a black pixel may be buried by a white pixel or may be replaced with an image which is prepared in advance.

The synthesizing unit 504 synthesizes the input video with the masked video and generates the masked video data (step S303). For example, the masked video data generated by the synthesizing unit 504 is data of a video illustrated in FIG. 6C. In the example of the masked video data illustrated in FIG. 6C, a portion of a black pixel of the masking image is synthesized with a masking image which is imaged by the imaging device 30 in advance under the same imaging conditions (a point-of-view position, a viewing angle, and the like). The masking image may be an image which is imaged in a state in which nothing is displayed on the image display device 102 or may be an image which is imaged in a state in which a predetermined image (for example, a logo mark, a landscape image, or the like) is displayed on the image display device 102.

The transmitting unit 505 transmits the masked video data generated by the synthesizing unit 504 to the terminal device 70 via the network 60 (step S304).

In the delivery system 1 having the above-described configuration, it is possible to cause a video of a field of view of a patron in the venue to be made different from a video delivered to a viewer of the user terminal. This will be described now. In the video shown at the field of view of the patron in the venue, the posture of the performer 20 on the stage 101 and the video displayed on the image display device 102 are shown together. However, in the video delivered to the viewer of the user terminal, the posture of the performer 20 is shown on the stage 101, but the video displayed on all or a part (a portion corresponding to the masking portion) of the image display device 102 is not shown. Thus, various kinds of problems that occur when the video imaged in the venue is displayed on the terminal device as is can be solved.

For example, even when the posture of the performer 20 of a living body and the posture of the performer 20 displayed on the image display device 102 come into a field of view at the same time, the patron of the venue does not feel dissatisfied. However, when the posture of the performer 20 of a living body and the posture of the performer 20 displayed on the image display device 102 are viewed on the terminal device 70 at the same time, the user of the terminal device 70 is likely to feel uncomfortable. In order to solve this problem, in the delivery system 1, all or a part of the image display device 102 is masked in the video viewed on the terminal device 70, and thus the posture of the performer 20 of a living body and the posture of the performer 20 displayed on the image display device 102 are prevented from coming into a field of view at the same time. Thus, the feeling of dissatisfaction rarely occurs.

In addition, in the venue, a performance according to the atmosphere of the place or a performance that can be felt without giving any feeling of dissatisfaction since the place is a field site may be made. In this case, when a video of the venue is displayed on the terminal device as is, the viewer of the terminal device may feel dissatisfied. More specifically, the following problem occurs. Here, when a video captured in a venue is synthesized with computer graphics (CG) or the like and then delivered to the user of the terminal device 70, an image corresponding to the CG may be displayed on the image display device 102 of the venue equipment 10. At this time, when the image displayed on the image display device 102 is delivered to the terminal device 70 as is, the video displayed on the image display device 102 overlaps with the video synthesized with the CG in terms of content and position. For this reason, it is difficult to provide a fresh video according to the user of the terminal device 70. Even with this problem, the occurrence of a feeling of dissatisfaction can be prevented by masking all or a part of the image display device 102 as described above.

### Modified Example

The arrangement position of the image display device 102 need not necessarily be limited to the back side of the stage 101, and the image display device 102 may be arranged at the side or the ceiling of the stage 101. In other words, the left wall 104 and the right wall 105 in FIG. 4 may be configured as the image display device. In this case, the left wall 104, the image display device 102, and the right wall 105 may be configured as one image display device.

The distance image-imaging device may be configured as a device integrated with the imaging device 30.

The display control unit 402 of the venue display control system 40 may cause the video imaged by the imaging device 30 not to be displayed on the image display device 102 as is, and may process the video imaged by the imaging device 30 and cause the processing result to be displayed on the image display device 102. For example, the display control unit 402 may perform processing of adding an image, text, or the like to the video imaged by the imaging device 30. In this case, it is possible to cause an image or text that can be viewed in the venue not to be viewed by the user of the terminal device 70. Further, the synthesizing unit 504 may perform processing of adding an image, text, or the like added by the display control unit 402 to the masked video data.

### Second Embodiment

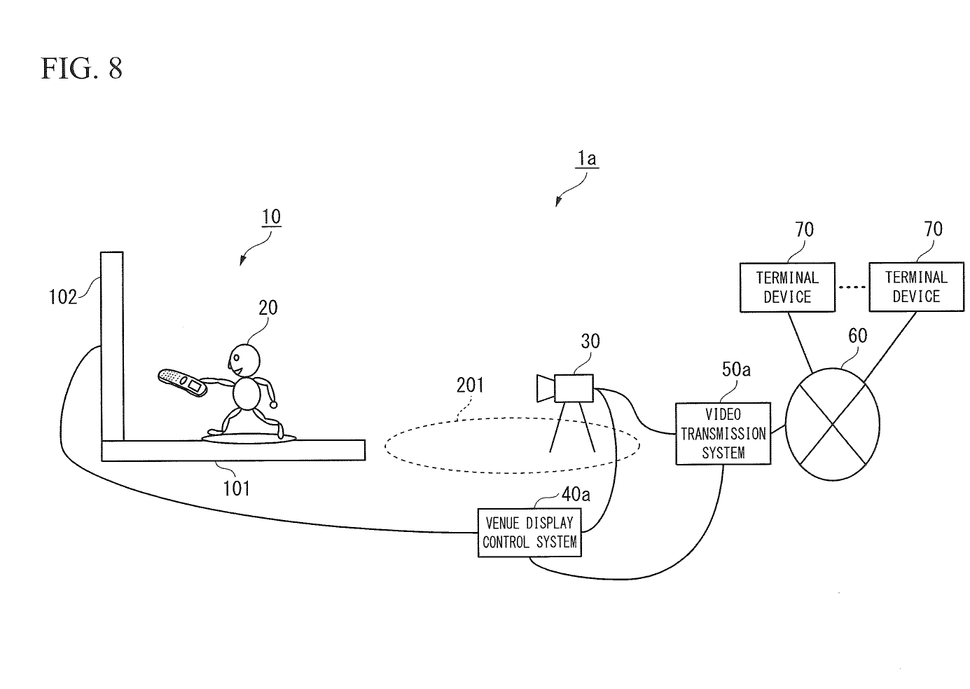

FIG. 8 is a system configuration diagram illustrating a system configuration according to a second embodiment (a delivery system 1a) of the present invention. In FIG. 8, the same components as in FIG. 1 are denoted by the same reference numerals, and a description thereof will not be made.

The delivery system 1a is different from in the first embodiment (the delivery system 1) in that a venue display control system 40a is provided instead of the venue display control system 40, and a video transmission system 50a is provided instead of the video transmission system 50, and the remaining configuration is the same. In the delivery system 1a, the venue display control system 40a transmits data of an image to the video transmission system 50a.

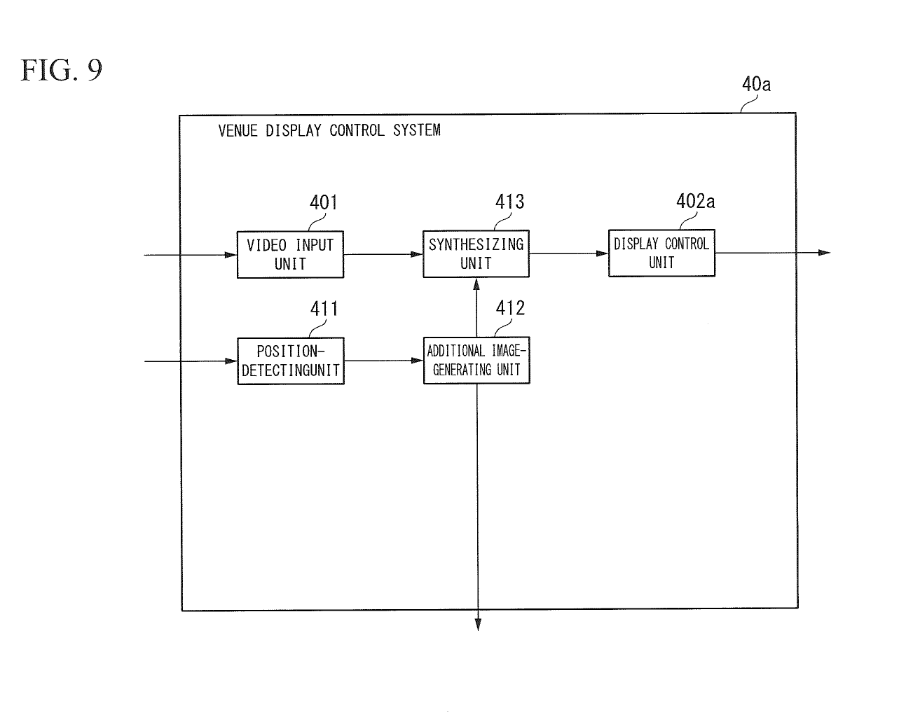

FIG. 9 is a schematic block diagram illustrating a functional configuration of the venue display control system 40a according to the second embodiment. The venue display control system 40a according to the second embodiment is different from the venue display control system 40 according to the first embodiment in that a position-detecting unit 411, an additional image-generating unit 412, and a synthesizing unit 413 are additionally provided, a display control unit 402a is provided instead of the display control unit 402, and the remaining configuration is the same as in the venue display control system 40 according to the first embodiment.

The position-detecting unit 411 detects the position of the performer 20. The position-detecting unit 411 generates information (hereinafter referred to as “position information”) representing the position of the performer 20, and outputs the position information to the additional image-generating unit 412. The position-detecting unit 411 may acquire the position information by any existing method. The following process may be used as a concrete example of a position-detecting process. The position-detecting unit 411 may detect the position of the performer 20 by performing a face tracking process of tracking the face of the performer 20 in the video. The position-detecting unit 411 may detect the position of the performer 20 by calculating a difference between the distance image generated by the distance image-imaging device and an initial value image (a distance image captured in a state in which the performer 20 is not present on the stage 101). The position-detecting unit 411 may detect the position of a position-detecting device 21 carried by the performer 20 as the position of the performer 20. In this case, for example, the position-detecting unit 411 may detect the position of the position-detecting device 21 by receiving infrared rays or a signal output from the position-detecting device 21.

The additional image-generating unit 412 generates an image (hereinafter referred to as an “additional image”) to be added to (synthesized with) the video input through the video input unit 401 according to the position information. The additional image-generating unit 412 outputs the generated image to the synthesizing unit 413. A plurality of concrete examples of an additional image-generating process performed by the additional image-generating unit 412 will be described.

(First Image-Generating Method)

The additional image-generating unit 412 includes an image storage device. The image storage device stores one type of image. The additional image-generating unit 412 reads an image from the image storage device. The additional image-generating unit 412 generates the additional image by changing the arrangement position of the read image according to the position information generated by the position-detecting unit 411. Then, the additional image-generating unit 412 outputs the additional image to the synthesizing unit 413.

(Second Image-Generating Method)

The additional image-generating unit 412 includes an image storage device. The image storage device stores a plurality of records in which the position information is associated with an image. The additional image-generating unit 412 reads an image according to the position information generated by the position-detecting unit 411 from the image storage device. The additional image-generating unit 412 outputs the read image to the synthesizing unit 413 as the additional image.

(Third Image-Generating Method)

The additional image-generating unit 412 includes an image storage device. The image storage device stores a plurality of records in which the position information is associated with an image. The additional image-generating unit 412 reads an image according to the position information generated by the position-detecting unit 411 from the image storage device. The additional image-generating unit 412 generates the additional image by changing the arrangement position of the read image according to the position information generated by the position-detecting unit 411. The additional image-generating unit 412 outputs the generated additional image to the synthesizing unit 413.

The concrete examples of the process of generating the additional image through the additional image-generating unit 412 have been described above, but the additional image-generating unit 412 may generate the additional image by a method different from the above-described method.

In addition, the additional image-generating unit 412 transmits the image read from the image storage device and the position information to the video transmission system 50a.

The synthesizing unit 413 generates a synthesis video by synthesizing the video input through the video input unit 401 with the additional image. The synthesizing unit 413 outputs the synthesis video to the display control unit 402a.

The display control unit 402a causes the synthesis video to be displayed on the image display device 102. The video (the synthesis video) in which the video (for example, the posture of the performer 20 or the like) imaged by the imaging device 30 is synthesized with the additional image is displayed on the image display device 102 with little delay.

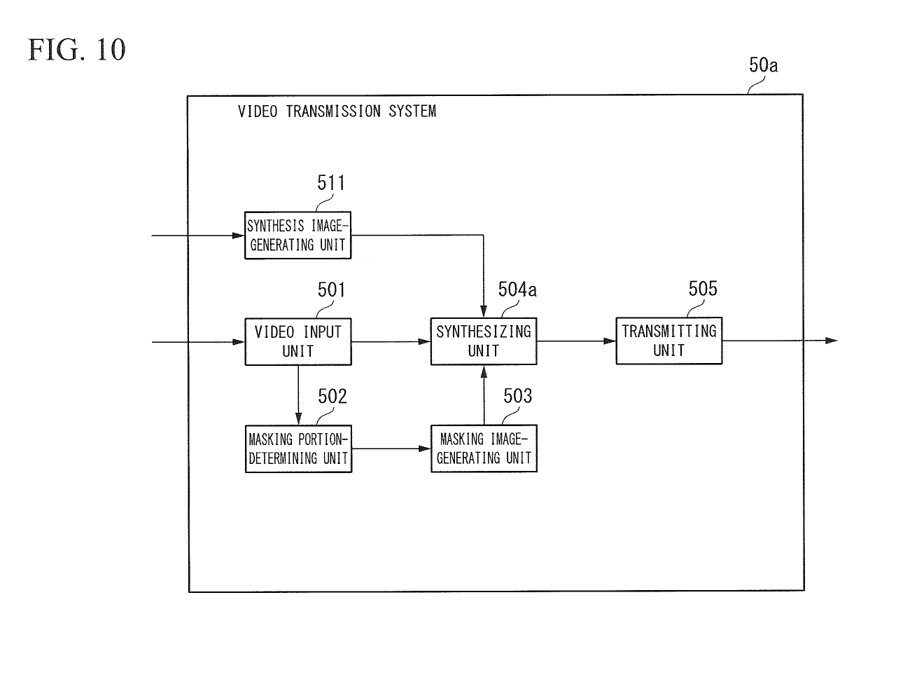

FIG. 10 is a schematic block diagram illustrating a functional configuration of the video transmission system 50a according to the second embodiment. The video transmission system 50a according to the second embodiment is different from the video transmission system 50 according to the first embodiment in that a synthesis image-generating unit 511 is further provided, and a synthesizing unit 504a is provided instead of the synthesizing unit 504, and the remaining configuration is the same as in the video transmission system 50 according to the first embodiment.

The synthesis image-generating unit 511 receives the image and the position information from the venue display control system 40a. The synthesis image-generating unit 511 generates a synthesis image based on the received image and the position information. For example, the synthesis image-generating unit 511 generates the synthesis image by processing the received image according to the position information. More specifically, the synthesis image-generating unit 511 detects the position on an image plane corresponding to the position on space coordinates represented by the position information in the image plane of the input video. Then, the synthesis image-generating unit 511 arranges the received image at the position apart from the detected position on the image plane by a predetermined distance. The synthesis image-generating unit 511 generates the synthesis image using a pixel with a transmissive value outside of a portion on which the received image is arranged.

The synthesizing unit 504a generates the masked video data by synthesizing the input video with the masking image and then further synthesizing the synthesis image. Thus, the synthesis image is synthesized and displayed on the masking portion. The synthesizing unit 504a outputs the masked video data to the transmitting unit 505.

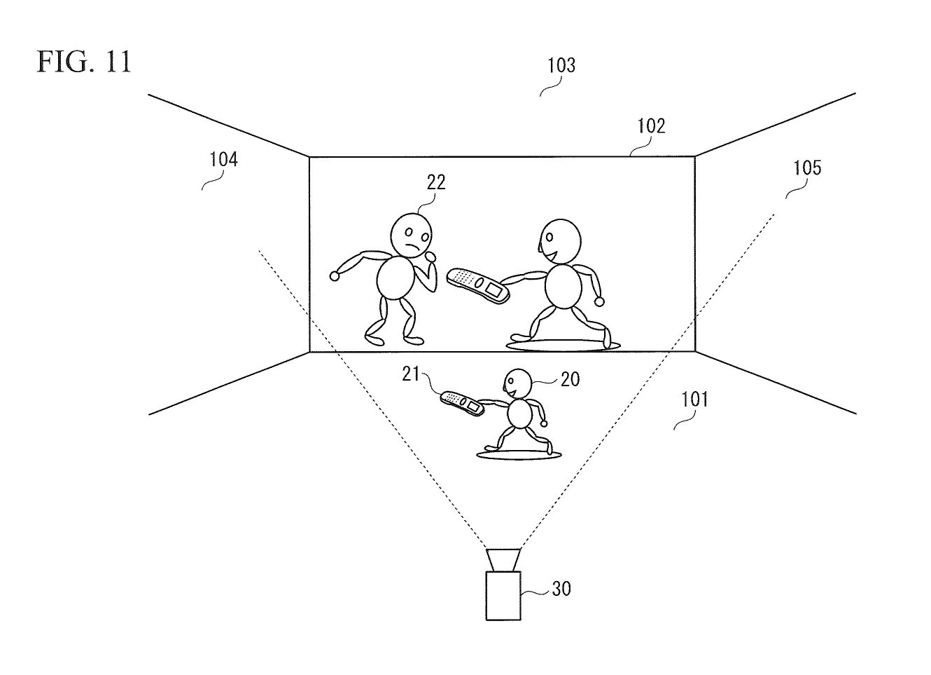

FIG. 11 is a diagram illustrating a concrete example of a state of the venue equipment 10 according to the second embodiment. In the example of FIG. 11, the performer 20 performs on the stage 101. The performer 20 carries the position-detecting device 21 as necessary. The image display device 102 is arranged at a back side near the performer 20 on the stage 101. In addition, a ceiling 103, a left wall 104, and a right wall 105 are arranged near the performer 20 on the stage 101. The imaging device 30 images the venue equipment 10 and the performer 20. The video imaged by the imaging device 30 is edited by the venue display control system 40, and the synthesis video is displayed on the image display device 102. In the example of FIG. 11, an image (which may be generated by the CG or may be generated using a photograph) of a virtual person 22 is synthesized as the additional image. As described above, the synthesis video is displayed on the image display device 102 with little delay, and thus the posture of the performer 20 almost matches the posture disposed on the image display device 102.

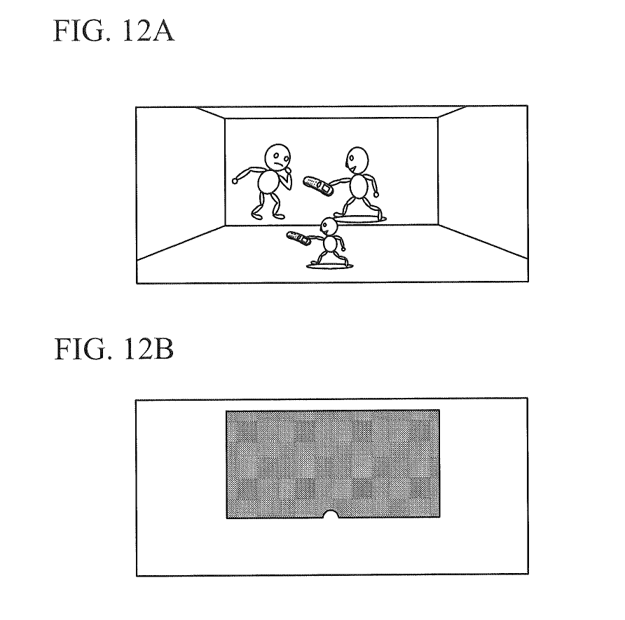

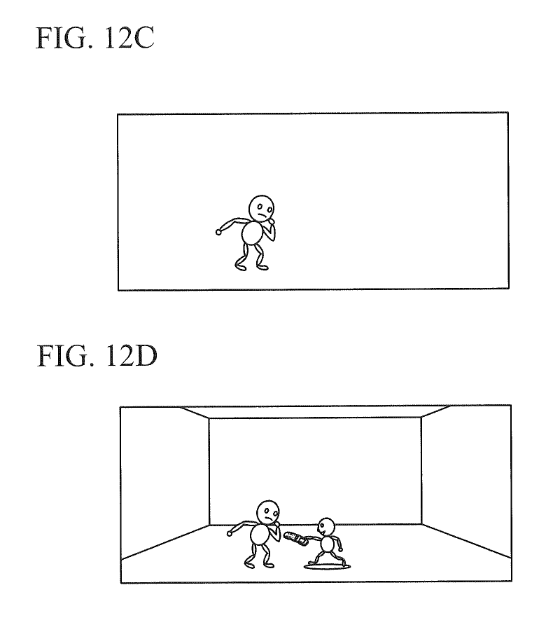

FIG. 12A to FIG. 12D are diagrams illustrating a concrete example of an image generated in the delivery system 1a according to the second embodiment. FIG. 12A is a diagram illustrating a concrete example of a video generated by the imaging device 30. FIG. 12B is a diagram illustrating a concrete example of the masking image. FIG. 12C is a diagram illustrating a concrete example of the synthesis image generated by the synthesis image-generating unit 511. FIG. 12D is a diagram illustrating a concrete example of the masked video data generated by the synthesizing unit 504.

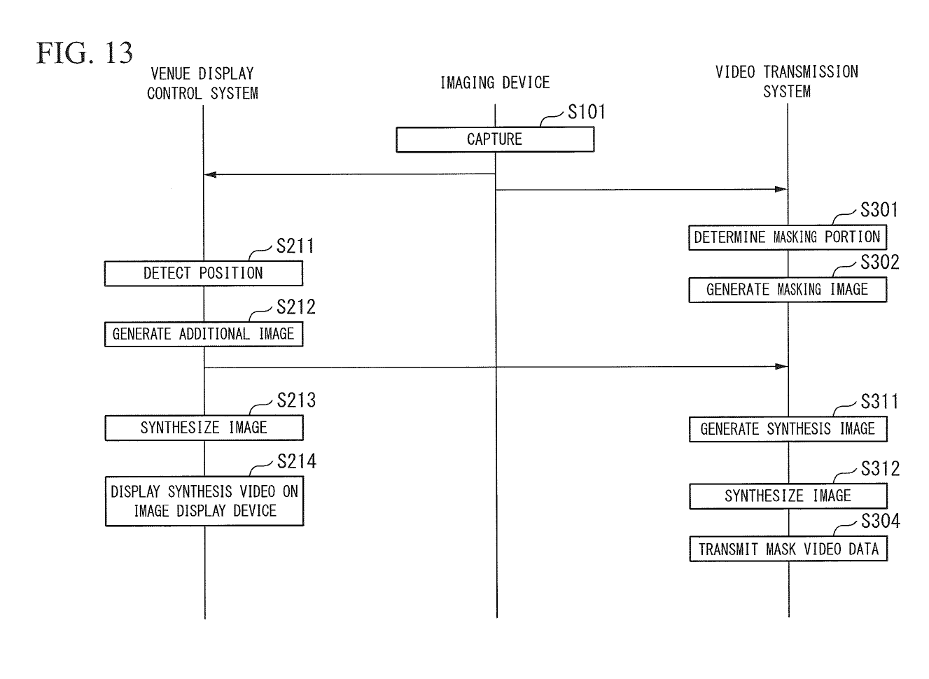

FIG. 13 is a sequence diagram illustrating the flow of a process according to the second embodiment (the delivery system 1a). The imaging device 30 images the image display device 102 and the performer 20 (step S101). For example, the video imaged by the imaging device 30 is a video illustrated in FIG. 12A. The imaging device 30 outputs the imaged video to the venue display control system 40a and the video transmission system 50a.

The venue display control system 40a detects the position of the performer 20 (step S211). Next, the venue display control system 40a generates the additional image (step S412). Further, the venue display control system 40a notifies the video transmission system 50a of the image and the position information which are used in the additional image. The venue display control system 40a synthesizes the additional image with the video imaged by the imaging device 30 (step S213), and causes the synthesis video to be displayed on the image display device 102 (step S214). At this time, the synthesizing unit 413 of the venue display control system 40a generates the synthesis video by enlarging a part (for example, a part in which the performer 20 is captured) of the imaged video and synthesizing the enlarged video with the synthesis image. Further, the synthesizing unit 413 of the venue display control system 40a may generate the synthesis video by enlarging a part (for example, a part in which the performer 20 is captured) of the synthesized video. By performing this control, the posture of the performer 20 can be displayed on the image display device 102 in a large way as illustrated in FIG. 12A.

The masking portion-determining unit 502 of the video transmission system 50a determines the masking portion based on the video imaged by the imaging device 30 (step S301). The masking image-generating unit 503 generates an image (the masking image) used to mask the masking portion determined by the masking portion-determining unit 502 (step S302). For example, the masking image generated based on the video of FIG. 12A is the masking image illustrated in FIG. 12B. The masking image illustrated in FIG. 12B is generated as a binary image of a white pixel and a black pixel. A video of a portion of a white pixel of the masking image is displayed as is after being synthesized. However, a video of a portion of a black pixel of the masking image is masked after being synthesized, and another video is displayed. For example, a portion of a black pixel may be buried by a white pixel or may be replaced with an image which is prepared in advance.

The synthesis image-generating unit 511 generates the synthesis image based on the image and the position information transmitted from the venue display control system 40a (step S311). For example, the synthesis image generated by the synthesis image-generating unit 511 is an image illustrated in FIG. 12C.

The synthesizing unit 504a generates the masked video data by synthesizing the input video with the masked video and then further synthesizing the synthesis image (step S312). For example, the masked video data generated by the synthesizing unit 504a is data of the video illustrated in FIG. 12D. In the example of the masked video data illustrated in FIG. 12D, a portion of a black pixel of the masking image is synthesized with a masking image which is imaged by the imaging device 30 in advance under the same imaging conditions (a point-of-view position, a viewing angle, and the like). The masking image may be an image which is imaged in a state in which nothing is displayed on the image display device 102 or may be an image which is imaged in a state in which a predetermined image (for example, a logo mark, a landscape image, or the like) is displayed on the image display device 102. In addition, in the example of the masked video data illustrated in FIG. 12D, the synthesis image is further synthesized on the masking image. Thus, in the example of the masked video data illustrated in FIG. 12D, the image of the virtual person 22 illustrated in FIG. 12C is displayed.

The transmitting unit 505 transmits the masked video data generated by the synthesizing unit 504a the terminal device 70 via the network 60 (step S304).

The delivery system 1a having the above-described configuration has the same effects as in the first embodiment (the delivery system 1).

In addition, the delivery system 1a has the following effects. In the delivery system 1a, the video (the synthesis video) in which the additional image is synthesized according to the position of the performer 20 is displayed on the image display device 102. The patron in the venue views the image display device 102 and can recognize interactions between the performer 20 and the virtual person 22. However, since the virtual person 22 is not actually present near the performer 20 of a living body, a feeling of dissatisfaction is likely to occur. On the other hand, in the masked video data displayed on the terminal device 70, the video in which the image of the virtual person 22 is synthesized is displayed near the actual performer 20 rather than the display surface of the image display device 102 as illustrated in FIG. 12D. Accordingly, interactions between the performer 20 and the virtual person 22 can be more naturally recognized.

### Modified Example

The additional image-generating unit 412 may not transmit the image read from the image storage device to the video transmission system 50a and may transmit the position information to the video transmission system 50a. In this case, the synthesis image-generating unit 511 of the video transmission system 50a may include an image storage device and may read an image used for generation of the additional image from the image storage device. In this case, the image read by the additional image-generating unit 412 may be different from or the same as the image read by the synthesis image-generating unit 511.

The position-detecting unit 411 may detect information (hereinafter referred to as “direction information”) representing a direction of the performer 20 or a direction of the position-detecting device 21 in addition to the position of the performer 20. In this case, the additional image-generating unit 412 may generate the additional image according to the direction information. Similarly, the synthesis image-generating unit 511 may generate the additional image according to the direction information. For example, the synthesis image-generating unit 511 may generate the synthesis image by arranging the received image at the position apart from the detected position on the image plane by a predetermined distance in a direction represented by the direction information. Through this configuration, a posture of a virtual person or the like drawn by the CG can be displayed in a direction in which the performer 20 faces. Accordingly, a performance such as interactions between the performer 20 and virtual person can be more naturally performed.

The image displayed as the additional image or the synthesis image need not be limited to the image of the virtual person 22. For example, a virtual living object (an animal or an imaginary living object) other than a human, a virtual object, text, or an image for a performance (an image representing an explosion) may be used as the additional image or the synthesis image.

The embodiments of the invention have been described above with reference to the accompanying drawings, but the concrete configuration is not limited to the above embodiments and includes a design or the like that does not depart from the gist of the invention.

What is claimed is:

1. A video transmission system, comprising:
a video input unit that receives a video from an imaging device that images the video as an input, the video including all or a part of an image display device arranged near a performer and the performer;
a mask-processing unit that performs a mask process on all or a part of a portion of the video in which the image display device is imaged; and
a transmitting unit that transmits the video that has been subjected to the mask process via a network.

2. The video transmission system according to claim 1,
wherein the image display device displays all or a part of the video imaged by the imaging device.

3. The video transmission system according to claim 1,
wherein the mask-processing unit determines the portion of the video in which the image display device is imaged as a masking portion, and synthesizes another image on the masking portion.

4. A video transmission method, comprising:
receiving a video from an imaging device that images the video as an input, the video including all or a part of an image display device arranged near a performer and the performer;
performing a mask process on all or a part of a portion of the video in which the image display device is imaged; and
transmitting the video that has been subjected to the mask process via a network.

5. A computer-readable recording medium in which a computer program is recorded, the computer program causes a computer to execute:
receiving a video from an imaging device that images the video as an input, the video including all or a part of an image display device arranged near a performer and the performer;
performing a mask process on all or a part of a portion of the video in which the image display device is imaged; and
transmitting the video that has been subjected to the mask process via a network.
